(19) United States
(12) Patent Application Publication
(10) Pub. No.: US 2010/0244711 A1
(43) Pub. Date: Sep. 30, 2010

(54) Self-Calibrating White Light Emitting Diode Module

(75) Inventors: Richard Landry Gray, Saratoga, CA (US); Po Ming Tsai, Taipei (TW)

Correspondence Address: Richard Landry Gray, 18900 Aspesi Drive, Saratoga, CA, 95070, US

(73) Assignee: Richard Landry Gray, Saratoga, CA (US)

(21) Appl. No.: 12/749,511

(22) Filed: Mar. 30, 2010

Related U.S. Application Data
(60) Provisional application No. 61/164,832, filed on Mar. 30, 2009.

(51) Int. Cl. H05B 37/02

(52) U.S. Cl. 315/185 R

(57) ABSTRACT

The self-calibrating WLED module in accordance with the present invention providing precisely matched current outputs by matching each output current to a reference current, wherein matching a current output to a current reference is done sequentially for a number of current outputs, restarting at a first current output after the last has been matched to the reference current. The module may be implemented with components that comprise multiple WLED strings, a controller, a transconductance amplifier, an input voltage, a generator, a reference module and multiple current regulators. The current regulators provide required current respectively to WLED strings by varying the current through the WLED strings.

### FIELD OF THE INVENTION

The present invention relates to a white light emitting diode (WLED) module, especially to a self-calibrating WLED module with current regulators.

### BACKGROUND OF THE INVENTION

White light emitting diodes (WLEDs) are used commonly in an array for residential or commercial use and have increased in popularity due to improved efficiency, extended lifetime and lower power consumption.

A conventional backlight for a notebook may require six parallel strings of WLEDs, and each string might have ten 100 miliwatt WLEDs connected in series. The voltage drop across each WLED may be 2 volts (V) and across each string may be 20V. The current through each string may be 10 mili-ampere (mA) to 100 mA depending on what type WLED is used. Furthermore, the current through each WLED string in a conventional WLED backlight has to be similar or matched closely. If currents through the WLED strings are significantly different, the WLED strings output different luminous levels, which results in inconsistent backlighting. Different currents through the WLED strings will cause the WLEDs to age at different rates and lead to WLED failure or light degradation.

A solution to overcome the foregoing problem is to provide each WLEDs string with an independent current regulator. Generally, the current regulators must provide current within 1% of each other to be used for an electronic application. However, cost and technical complexity of such an approach causes the solution to be prohibitive. The technical complexity of separate current regulators adds significantly to the number of electrical components, which reduces system reliability.

With reference to FIG. 1, a conventional LED module comprises multiple strings of WLED (11), a power supply (12) and multiple current regulators (13).

Each string of WLEDs (11) has a high voltage end, a low voltage end and multiple WLED diodes. The WLED diodes are connected in series.

The high voltage end is connected to the power supply (12).

The current regulators (13) are connected respectively to the low voltage ends of the WLED strings (11) and force the same current to flow through all the strings of WLEDs (11).

For a power supply (12) to drive multiple strings of WLEDs (11), the voltage drop for each string of WLEDs (11) has to be large enough to enable the corresponding current regulator (13). Otherwise, the current is out of compliance. When the voltage applied across the string of WLEDs (11) is not high enough to enable the current regulator (13) to regulate the current, the current regulator (13) is said to “be out of compliance.”

To overcome such a problem simply requires a power supply (12) that provides a high enough voltage to the strings of WLED (11) and current regulators (13) under all operating conditions. However, operating the power supply (12) at a voltage higher than the minimum necessary to provide current to all the strings of WLED (11) causes the efficiency of the whole system to suffer from unnecessary power dissipation in the form of heat loss from the current regulators.

Therefore, LED module manufactures are eager to develop a luminant device with an optimal power supply, multiple strings of WLEDs and multiple current regulators, in which luminance of the strings of WLEDs match to a high accuracy without having to use specially matched or trimmed components.

### SUMMARY OF THE INVENTION

The objective of the present inventions is to provide a self calibrating WLED module using a calibration current to sequentially calibrate multiple strings of WLEDs in order to achieve better current accuracy in each string of WLEDs.

The self-calibrating WLED module in accordance with the present invention comprises multiple WLED strings and each WLED string having two ends, one end being connected to a stable voltage source; and multiple current regulators being connected to the other end of the corresponding WLED string, saving a voltage indicative of a desired current and comprising a pair of current sources, a reference current source being used in a servo loop configuration to force another current source to provide the same voltage across the current source that was apparent when the reference current was switched to the current source output.

The self-calibrating WLED module providing precisely matched current outputs by matching each output current to a reference current, wherein matching a current output to a current reference is done sequentially for a number of current outputs, restarting at a first current output after the last has been matched to the reference current.

The self-calibrating WLED module may be implemented with components that comprise multiple WLED strings, a controller, a transconductance amplifier, an input voltage, a generator, a reference module and multiple current regulators. The current regulators provide required current respectively to the WLED strings by varying the current through the WLED strings.

### BRIEF DESCRIPTIONS OF THE DRAWINGS

FIG. 1 is a circuit diagram of a conventional white light emitting diode (WLED) array;

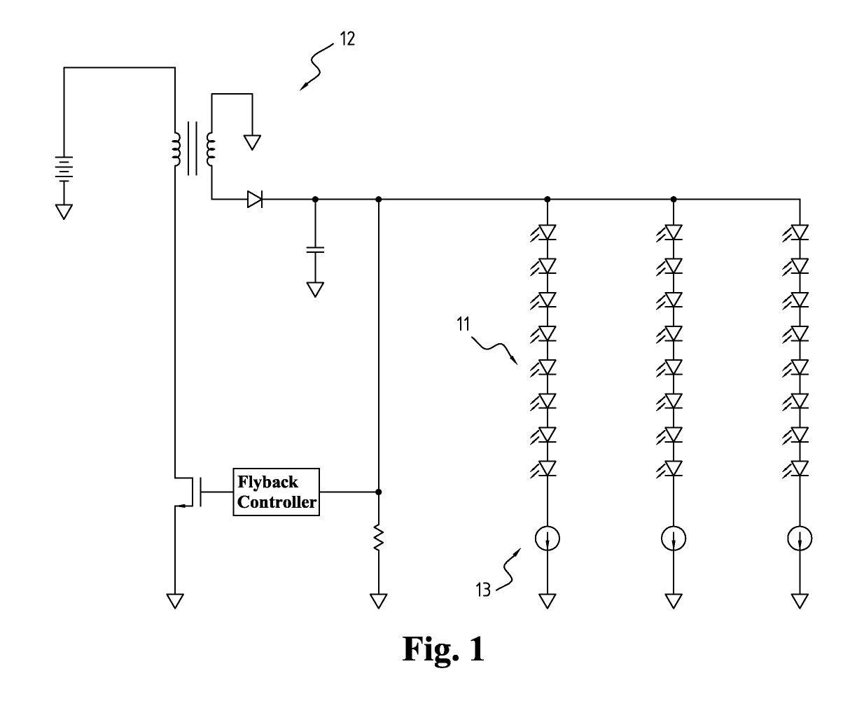

FIG. 2 is a block diagram of a WLED array with a self calibrating current regulator in accordance with the present invention;

FIG. 3 is a circuit diagram of one stage of current self calibrating current regulator in FIG. 2;

FIG. 4 is a circuit diagram of a self-calibrating WLED module with a current stabilizer and a startup detector in accordance with the present invention; and

FIG. 5 is a block diagram of the startup detector in FIG. 4.

### DETAILED DESCRIPTION OF THE PRESENT INVENTION

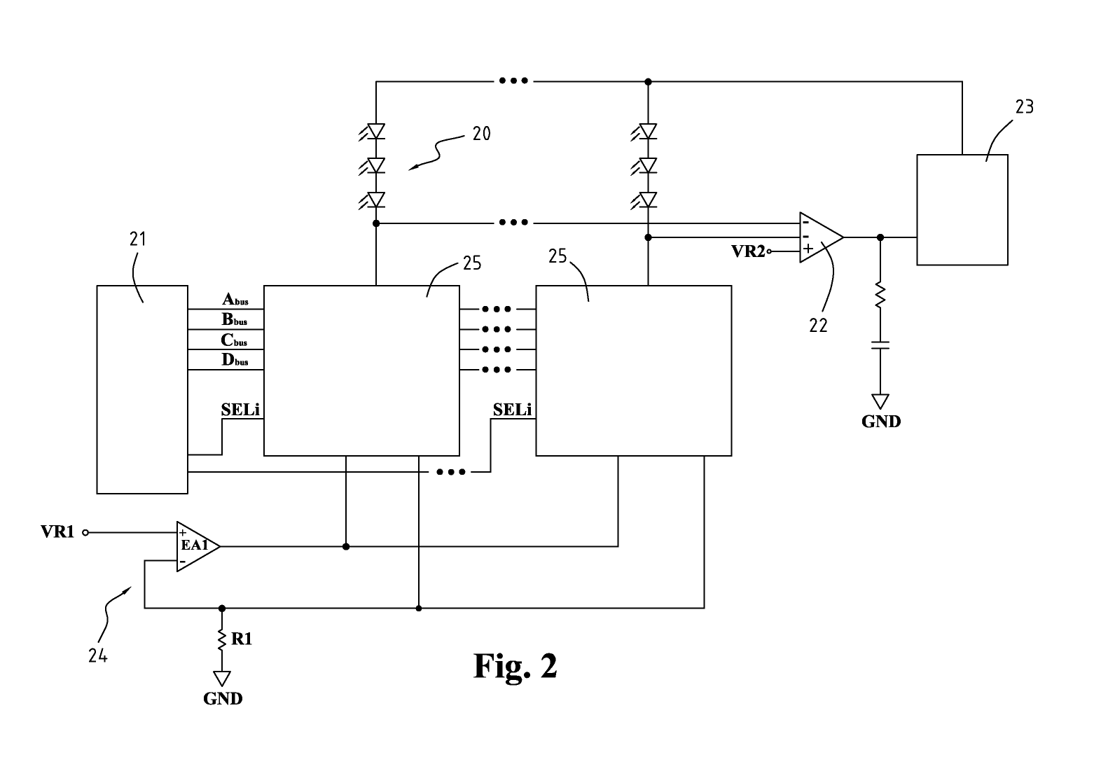

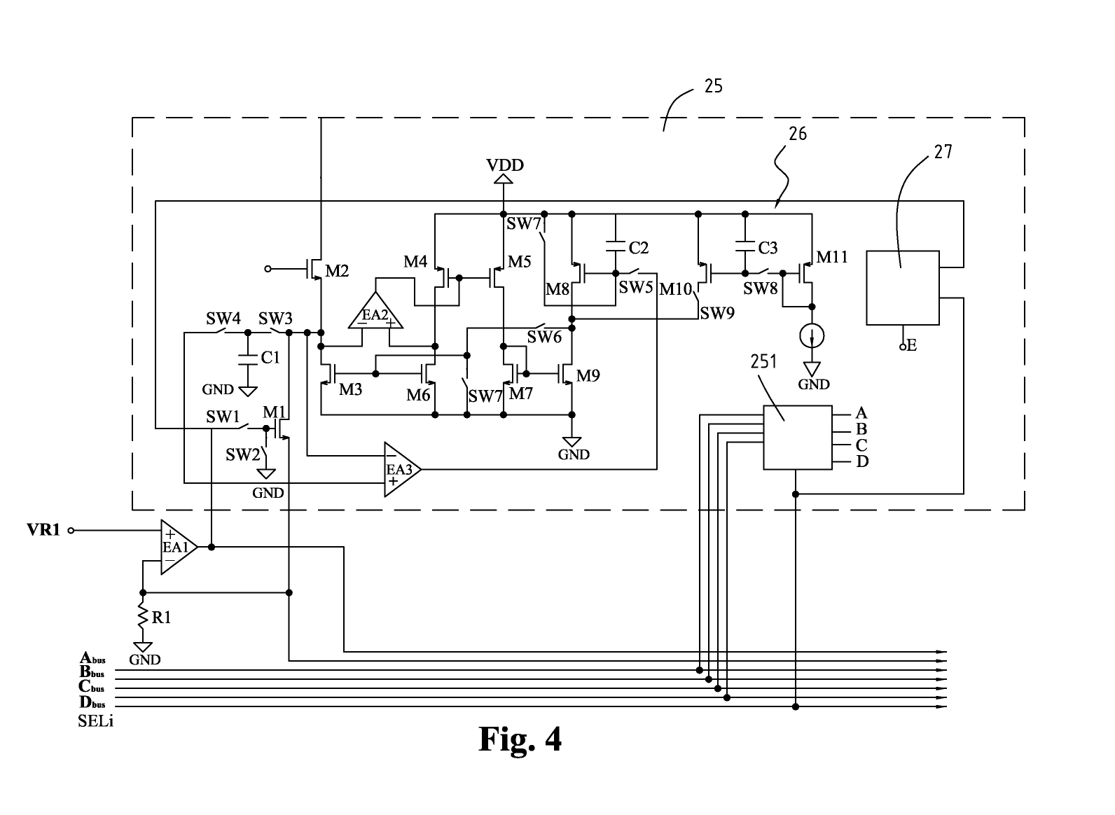

With reference to FIGS. 2 and 4, a self-calibrating white light emitting diode (WLED) module in accordance with the present invention comprises multiple WLED strings (20), a controller (21), a transconductance amplifier (22), an input voltage (VR2), a generator (23), a reference module (24), multiple current regulators (25), an optional current stabilizer (26) and an optional startup detector (27)

Each WLED string (20) has multiple WLED diodes and has a high voltage end and a low voltage end. The WLED diodes are connected in series.

The WLED string (20) may have different numbers of diodes. Experiments performed by the inventor have shown that the self calibrating WLED module working quite well when the WLED diodes in each WLED string (20) are mismatched purposely.

The controller (21) controls the self-calibrating WLED module and comprises multiple sequence signals (SELi) and four control signals (Abus˜Dbus) (i.e. a first control signal (Abus), a second control signal (Bbus), a third control signal (Cbus) and a fourth control signal (Dbus)). The sequence signals (SELi) correspond to the WLED strings (20). The four control signals (Abus˜Dbus) control calibration sequences respectively of the WLED strings (20) according to the sequence signal (SELi).

Each of the foregoing signals (Abus˜Dbus, SELi) has a HIGH voltage potential and a LOW voltage potential.

The operational transconductance amplifier (22) is a multiple negative input amplifier that is a “lowest one wins” architecture that dictates an output current based on voltage difference between the positive input terminal and the lowest of the multiple negative input terminals and comprises a positive input terminal, multiple negative input terminals and an output terminal. The negative input terminals are connected respectively to the low voltage ends of the WLED strings (20).

The generator (23) has an input and an output. The output of the generator (23) is connected to the high voltage ends of the WLED strings (20). The input of the generator (23) is connected to the output terminal of the transconductance amplifier (22).

The generator (23) receives the output from the transconductance amplifier (22) and provides just enough voltage to drive the WLED strings (20) so that the current through the WLED strings (20) achieve the desired value.

The reference module (24) controls brightness of the WLED diodes and comprises a ground (GND), an input reference voltage (VR1), a resistor (R1) and an amplifier (EA1).

The input reference voltage (VR1) drives the reference module (24) and is optimally a ramp signal that moves from 0 volts to some reference voltage and back to 0 volts in a controlled fashion in order to keep the current of each WLED string (20) from changing appreciably during calibration and reducing current spikes.

The resistor (R1) has two ends. One end of the resistor (R1) is connected to ground (GND).

The amplifier (EA1) comprises a positive input terminal, a negative input terminal and an output terminal. The positive input terminal receives the input reference voltage (VR1). The negative input terminal is connected to the end of the resistor (R1) opposite to ground (GND).

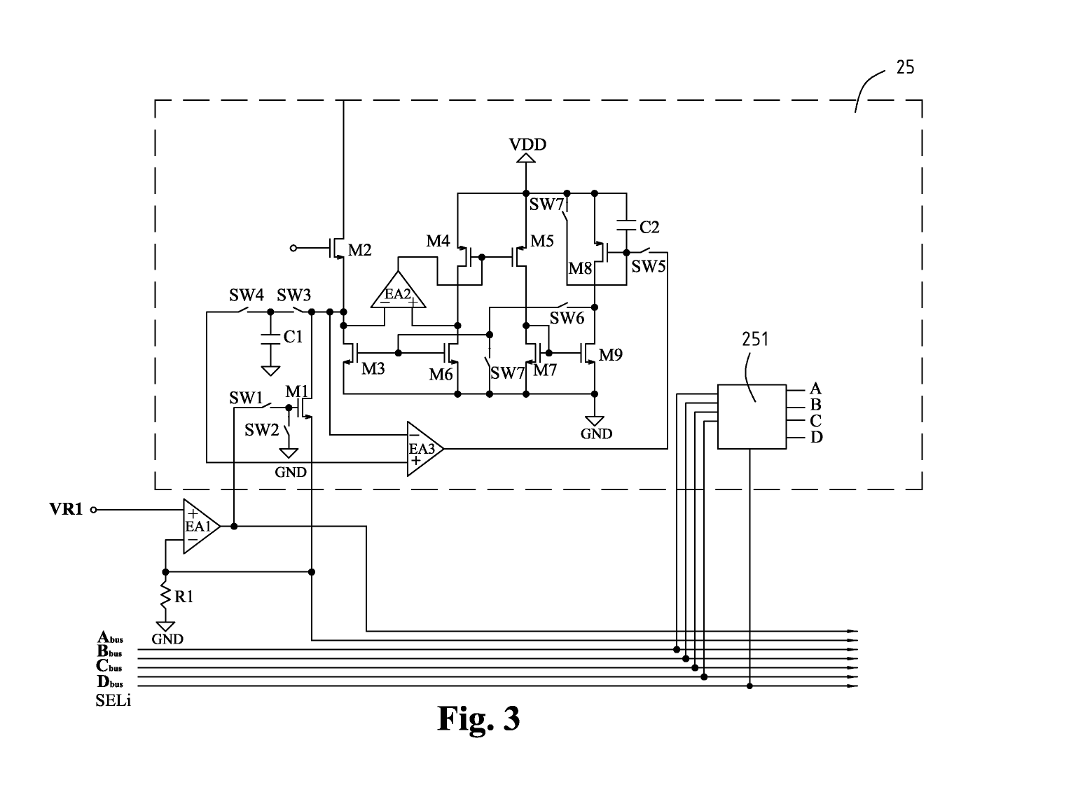

With further reference to FIGS. 3 and 4, the current regulators (25) regulate current in the WLED strings (20) and are connected respectively to the WLED strings (20) and the output terminal of the amplifier (EA1). Each current regulator (25) provides a calibrated current to the corresponding WLED strings (20) and receives the four control signals (Abus˜Dbus) and the sequence signal (SELi).

The current regulator (25) comprises a ground (GND), a V_{DD} source (VDD), a first transistor (M1), a second transistor (M3), a first error amplifier (EA2), a second error amplifier (EA3), a third transistor (M4), a fourth transistor (M5), a fifth transistor (M6), a sixth transistor (M7), a seventh transistor (M8), a first capacitor (C1), a second capacitor (C2), an eighth transistor (M9), a logic module (251), multiple switches (SW1 . . . 7) and an optional protecting transistor (M2).

The logic module (251) receives the four control signals (Abus˜Dbus) and the sequence signal (SELi) from the controller.

When the sequence signal (SELi) is HIGH, the logic module (251) passes the four control signals (Abus˜Dbus) directly through to the corresponding control signals (A˜D).

When the sequence signal (SELi) is LOW, the logic module (251) causes all the four corresponding control signals (A˜D) to be low, regardless of the state of the four control signals (Abus˜Dbus). In this way each current regulator (25) can be sequentially calibrated.

The multiple switches (SW1 . . . 7) are controlled by the voltage potential of the corresponding control signals (A˜D) and comprise a first switch (SW1), a second switch (SW2), a third switch (SW3), a fourth switch (SW4), a fifth switch (SW5), a sixth switch (SW6) and two seventh switches (SW7).

The first switch (SW1) is controlled by the first corresponding control signal (A), which is closed when the first corresponding control signal (A) is HIGH.

The second switch (SW2) is controlled by the first corresponding control signal (A), which is closed when the first corresponding control signal (A) is LOW.

The third switch (SW3) is controlled by the second corresponding control signal (B), which is closed when the second corresponding control signal (B) is HIGH.

The fourth switch (SW4) is controlled by the second corresponding control signal (B), which is closed when the second corresponding control signal (B) is LOW.

The fifth switch (SW5) is controlled by the third corresponding control signal (C), which is closed when the third corresponding control signal (C) is LOW.

The sixth switch (SW6) is controlled by the fourth corresponding control signal (D), which is closed when the fourth corresponding control signal (D) is HIGH.

The seventh switches (SW7) are closed when the fourth corresponding control signal (D) is LOW.

The first transistor (M1) is activated to provide calibration current to the WLED string (20) and comprises a drain, a source and a gate. The source of the first transistor (M1) is connected to the negative input terminal of the amplifier (EA1) and the resistor (R1). The gate of the first transistor (M1) is connected to the output terminal of the amplifier (EA1) through the first switch (SW1) and is connected to ground (GND) through the second switch (SW2).

The first transistor (M1) activates and provides current to the WLED string (20) when the first switch (SW1) is closed. The first transistor (M1) is deactivated when the when the first switch (SW1) is opened and consequently the second switch (SW2) is closed.

The second transistor (M3) comprises a drain, a gate and a source. The drain of the second transistor (M3) is connected to the drain of the first transistor (M1). The source of the second transistor (M3) is connected to ground (GND).

The second transistor (M3) provides current to the WLED string (20) when the current regulator (25) is not calibrating the WLED string (20) (i.e. when the first transistor (M1) is deactivated) and then stops producing required current to the WLED string (20) when the seventh switches (SW7s) are closed.

The first error amplifier (EA2) comprises a negative input terminal, a positive input terminal and an output terminal. The negative input terminal of the first error amplifier (EA2) is connected the drain of the second transistor (M3).

The second error amplifier (EA3) forces current to flow to the drain of the second transistor (M3) and the WLED string (20) and comprises a negative input terminal, a positive input terminal and an output terminal. The negative input terminal of the second error amplifier (EA3) is connected to the drain of the second transistor (M3).

The third transistor (M4) comprises a drain, a source and a gate. The drain of the third transistor (M4) is connected to the positive input terminal of the first error amplifier (EA2). The gate of the third transistor (M4) is connected to the output terminal of the first error amplifier (EA2). The source of the third transistor (M4) is connected to the V_{DD} source (VDD).

The fourth transistor (M5) comprises a drain, a gate and a source. The gate of the fourth transistor (M5) is connected to the gate of the third transistor (M4) and the output terminal of the first error amplifier (EA2). The source of the fourth transistor (M5) is connected to the V_{DD} source (VDD).

The fifth transistor (M6) comprises a drain, a source and a gate. The drain of the fifth transistor (M6) is connected to the positive input terminal of the first error amplifier (EA2) and the drain of the third transistor (M4). The source of the fifth transistor (M6) is connected to ground (GND). The gate of the fifth transistor (M6) is connected to the gate of the second transistor (M3) and is connected to ground (GND) through the seventh switches (SW7).

The fifth transistor (M6), the second transistor (M3) and the first error amplifier (EA2) form a servo loop to provide a current sensing capability. The servo loop ensures the drain voltage of the second transistor (M3) is equal to the drain voltage of the fifth transistor (M6) when the required current flows through the drain of the second transistor (M3).

The sixth transistor (M7) comprises a drain, a gate and a source. The drain of the sixth transistor (M7) is connected to the drain of the fourth transistor (M5). The gate of the sixth transistor (M7) is connected to the drain of the fourth transistor (M5). The source of the sixth transistor (M7) is connected to ground (GND).

The seventh transistor (M8) comprises a drain, a gate and a source. The drain of the seventh transistor (M8) is connected to the gates of the second transistor (M3) and the fourth transistor (M6) through the sixth switch (SW6). The gate of the seventh transistor (M8) is connected to the output terminal of the second error amplifier (EA3) through fifth switch (SW5) and also connected to the V_{DD} source (VDD) through the seventh switches (SW7). The source of the seventh transistor (M8) is connected to the V_{DD} source (VDD).

The first capacitor (C1) has two ends and a sampled voltage that samples the drain voltage of the second transistor (M3) and the drain voltage of first transistor (M1). One end of the first capacitor (C1) is connected to ground (GND). The other end of the first capacitor (C1) is connected to the positive input terminal of second error amplifier (EA3) through the fourth switch (SW4), and also connected to the negative input terminal of the second error amplifier (EA3), the negative input terminal of the first error amplifier (EA2) and the drains of the first transistor (M1) and the second transistor (M3).

The first capacitor (C1) samples the drain voltage of the second transistor (M3) and first transistor (M1) when the third switch (SW3) is closed (the fourth switch (SW4) is opened) and consequently the second transistor (M3) is deactivated and the calibration current flows through the first transistor (M1).

The sampled voltage is then used to stabilize the current through the WLED string (20) to match the calibration current with the current provided by the second transistor (M3). The stored voltage (the sampled voltage) remains in the first capacitor (C1) until the charge leaks off or the third switch (SW3) is closed again and a new value of drain voltage on first and second transistors (M1, M3) is again sampled. Therefore, the voltage stored in the first capacitor (C1) is used to “remember” the drain voltage of the second transistor (M3) that produces the required (optimal) current through the WLED string (20).

The second capacitor (C2) has two ends and is used to store a voltage. One end of the second capacitor (C2) is connected to the gate of the seventh transistor (M8), the V_{DD} source (VDD) through the seventh switch (SW7) and the output terminal of the second error amplifier (EA3) through the fifth switch (SW5). The other end of the second capacitor (C2) is connected to the V_{DD} source (VDD).

The voltage stored in the second capacitor (C2) causes the required current of the second transistor (M3) to be equal to the calibration current, and forces current through the seventh transistor (M8) that is indicative of the required current through the second transistor (M3) when the fifth switch (SW5) is closed.

The eighth transistor (M9) comprises a drain, a gate and a source. The drain of the eighth transistor (M9) is connected to the drain of the seventh transistor (M8). The gate of the eighth transistor (M9) is connected to the gate and the drain of the sixth transistor (M7). The source of the eighth transistor (M9) is connected to ground (GND).

Further, the mirrored current (from the transistors (M3, M6, M4, M5, and M7)) through eighth transistor (M9) is compared to the current through seventh transistor (M8) in order to produce a voltage at the drain of eighth transistor (M9) that is fed back to the gates of second transistor (M3) to complete the servo loop.

The second error amplifier (EA3) has a positive input, a negative input and an output. The positive input of the second error amplifier (EA3) is connected to the first capacitor (C1) through fourth switch (SW4). The negative input of the second error amplifier (EA3) is connected to the drain of the second transistor (M3). The output of the second error amplifier (EA3) is connected to the one end of the second capacitor (C2) that is opposite to the V_{DD} source (VDD).

The second error amplifier (EA3) forces the drain voltage of the second transistor (M3) to be equal to the voltage (sampled voltage) stored on the first capacitor (C1), thus causing the required current to flow through the WLED string (20). Nevertheless, the second error amplifier (EA3) no longer (indirectly) forces the drain voltage of the second transistor (M3) to cause the required current to flow to the WLED string (20) when the fifth switch (SW5) is opened. The most recent voltage at the output of second error amplifier (EA3) is stored on the second capacitor (C2) which causes the required current to flow through the second transistor (M3) even though a servo loop through second error amplifier (EA3) is broken.

The protecting transistor (M2) provides voltage protections to the drain of the first transistor (M1) and the second transistor (M3) and the negative input of the first error amplifier (EA2) and comprises a gate, a drain and a source. The gate of the protecting transistor (M2) is connected to an external cascode bias circuit. The drain is connected to the low voltage end of the WLED string (20). The source of the protecting transistor (M2) is connected to the drain of the first transistor (M1), the negative input terminal of the second error amplifier (EA3), the negative input terminal of the first error amplifier (EA2) and the drain of the second transistor (M3). The source voltage of the protecting transistor (M2) will not rise above the gate voltage due to cascoding effects of the protecting transistor (M2).

During startup, the voltage at the drain of first transistor (M1) may not be indicative of the actual voltage required to produce the desired current in the WLED string (20) because the current in the WLED string (20) is at some unknown intermediate value and the voltage at the drain of the first transistor (M1) is almost zero. Therefore the relation between drain voltage of (M1) and the current through WLED string (20) is not well defined and is unable to provide reliable feedback during start up.

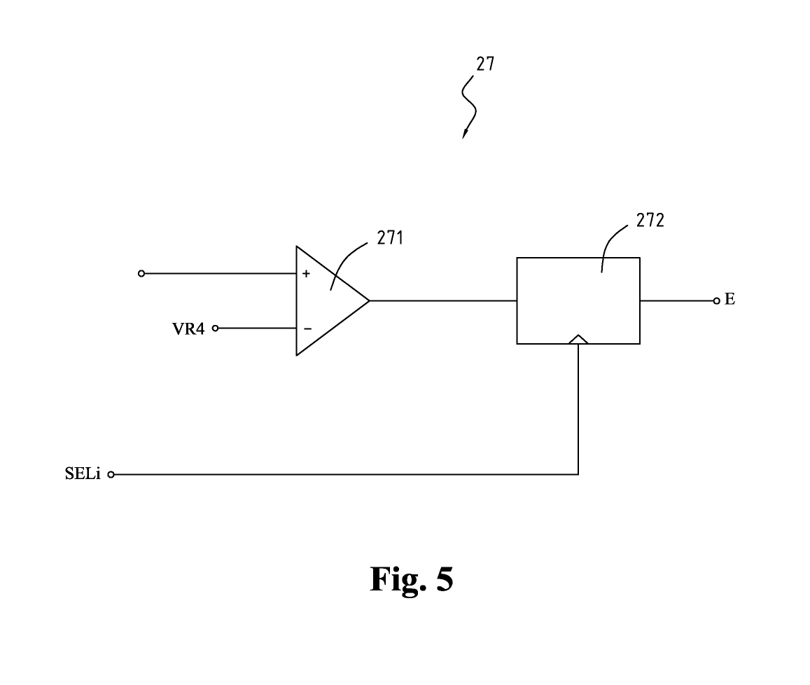

With reference to FIGS. 4 and 5, in order to circumvent this above-mentioned start up problem, the self-calibrating white light emitting diode (WLED) module in accordance with the present invention may further comprise the current stabilizer (26) and the startup detector (27) that produces a current that replicates the current that flows through the first transistor (M1) divided by a constant K.

The startup detector (27) generates a fifth control signal (E) when the current regulator (25) is unable to provide its desired current and comprises an external second reference voltage (VR4), a D Flip-Flop (272) and a comparator (271).

The comparator (271) comprises a positive input terminal, a negative input terminal and an output terminal. The positive input terminal is connected to the gate of the first transistor (M1). The negative input terminal is connected to the second reference voltage (VR4). The output terminal of the comparator (271) is connected to the D Flip-Flop (272) and generates a reset signal that is based on the comparison of the gate voltage of the first transistor (M1) and the second reference voltage (VR4), which if sufficiently high, resets the D Flip-Flop (272) making the fifth control signal (E) go high and enabling the current stabilizer (26).

The current stabilizer (26) comprises a ground (GND), a ninth transistor (M10), a tenth transistor (M11), a third capacitor (C3), a eighth switch (SW8) and a ninth switch (SW9).

The eighth switch (SW8) is controlled by the first corresponding control signal (A) and is closed when the first corresponding control signal (A) is HIGH.

The ninth switch (SW9) is controlled by the fifth control signal (E) and closed when the fifth control signal (E) is HIGH.

The ninth transistor (M10) comprises a drain, a source and a gate. The drain of the ninth transistor (M10) is connected to the drains of the seventh transistor (M8) and the eighth transistor (M9) through the ninth switch (SW9). The source of the ninth transistor (M10) is connected to the V_{DD} source (VDD).

The current flows through the ninth transistor (M10) to the drain of the eighth transistor (M9) when the ninth switch (SW9) is closed.

The tenth transistor (M11) comprises a drain, a source and a gate. The drain of the tenth transistor (M11) is connected to a current source that is a fraction of the current in first transistor (M1) when it is providing the current through the WLED string (20). The source of the tenth transistor (M11) is connected to the V_{DD} source (VDD). The gate of the tenth transistor (M11) is connected to the drain of the tenth transistor (M11) and also connected to the gate of the ninth transistor (M10) through the eighth switch (SW8).

The third capacitor (C3) has two ends. One end of the third capacitor (C3) is connected to the gate of the ninth transistor (M10) and the gate of the tenth transistor (M11) through the eighth switch (SW9). The other end of the third capacitor (C3) is connected to the V_{DD} source (VDD).

The current, proportional to current in the first transistor (M1) that flowed through the tenth transistor (M11) is saved as a voltage across the third capacitor (C3). The saved voltage induces a current in the ninth transistor (M10) that will, in turn, force current in the second transistor (M3) to be equal to that of the first transistor (M1). In this way, during startup when the normal servo loop through the second error amplifier (EA3) is inoperable due to low drain voltages at the first transistor (M1) and the second transistor (M3), current flowing through the ninth transistor (M10) into the eighth transistor (M9) forms an alternate feedback path. The alternate feedback path forces current through the second transistor (M3) to approach that of the first transistor (M1) even though the first transistor (M1) current has been unable to reach its desired value because the voltage across the corresponding WLED string (20) is not high enough yet to support the desired current. Eventually the generator (23) provides sufficient voltage to the WLED strings (20), which allows the desired current to flow through the WLED strings (20). At this point in time the startup detector (27) disables the current stabilizer (26) allowing the normal feedback path through the second error amplifier (EA3) to take over operation.

Further, modern lighting solutions are often required to provide some means of efficiently varying the light output of the lighting device. The present invention can provide dimming functions by using an analog dimming or a pulse width modulation (PWM) dimming method.

The analog dimming is performed by adjusting the values of the input reference voltage (VR1) and the resistor (R1) that produces different brightness level in different current levels.

PWM dimming turns a WLED ON and OFF at a frequency higher than the human eye can detect. When using PWM dimming with this invention one must synchronize duty cycles of PWM dimming with the calibration cycles. A minimum time must be provided for the current regulator to perform its calibration cycle.

People skilled in the art will understand that various changes, modifications and alterations in form and details may be made without departing from the spirit and scope of the invention.

What is claimed is:

1. A self-calibrating white light emitting diode (WLED) module comprising
multiple WLED strings and each WLED string having two ends, one end being connected to a relatively stable voltage source; and
multiple current regulators, each current regulator being connected to the corresponding WLED string, saving voltage and current to regulate current output and comprising a pair of current sources, one current source being used in a servo loop configuration to force another current source to provide same voltage across the current source while a reference current is switched to the current source output.

2. The self-calibrating WLED module as claimed in claim 1, wherein the voltage, indicative of a particular WLED string current, is saved on a capacitor.

3. The self-calibrating WLED module as claimed in claim 1, wherein the loop that determines the voltage of the relatively stable voltage source, senses multiple inputs and regulates based on the voltage of a lowest input.

4. The self-calibrating WLED module as claimed in claim 1, wherein the reference current is based on an input reference voltage and a resistor.

5. The self-calibrating WLED module as claimed in claim 1, wherein the input reference voltage is a ramp signal that moves from 0 volts to some reference voltage and back to 0 volts.

6. The self-calibrating WLED module as claimed in claim 5 further providing a dimming function using an analog dimming function performed by adjusting values of the input reference voltage and the resistor that producing different brightness level in different current levels.

7. The self-calibrating WLED module as claimed in claim 1 providing a dimming function using PWM dimming turning a load ON and OFF at a frequency higher than the human eye can detect, synchronizing duty cycles of PWM dimming to calibration cycles and allowing a minimum required time for the current regulator to perform calibration cycles.

8. A self-calibrating WLED module providing precisely matched current outputs by matching each output current to a reference current, wherein matching a current output to a current reference is done sequentially for a number of current outputs, restarting at a first current output after the last has been matched to the reference current.

9. A self-calibrating WLED module comprising
an input voltage;
multiple WLED strings having multiple WLED diodes connected in series and comprising a high voltage end and a low voltage end;
a controller controlling the self-calibrating WLED module and comprising
multiple sequence signals, the numbers of sequence signal corresponding to the WLED strings, and each sequence signal having a HIGH voltage potential and a LOW voltage potential; and
multiple control signals respectively controlling calibration sequences of the self calibrating WLED module according to the sequence signal;
a transconductance amplifier having multiple negative inputs and one positive input, dictating an output current based on the differential voltage between the positive input voltage and the lowest of the negative input voltages, each of the negative inputs being connected to the low voltage end of each of the WLED strings;
a generator having an output and an input being connected respectively to the high voltage ends of the WLED strings and the output terminal of the transconductance amplifier, receiving the output from the transconductance amplifier and providing enough voltage to drive the WLED strings;
a reference module being a relatively stable voltage source; and
multiple current regulators regulating current in the WLED strings and being connected respectively to the corresponding WLED strings, and each current regulator providing a calibrated current, based on current from a reference module, to the corresponding WLED strings and receiving the control signals and the sequence signal.

10. The self-calibrating WLED module as claimed in claim 9, wherein multiple control signals comprise first, second, third and fourth control signals.

11. The self-calibrating WLED module as claimed in claim 9, wherein the generator has an input and an output, the input of the generator is connected to the high voltage ends of the WLED strings, the output of the generator is connected to the output terminal of the transconductance amplifier.

12. The self-calibrating WLED module as claimed in claim 10, wherein the reference module controls brightness of the WLEDs and comprises
a ground;
an input reference voltage driving the reference module in order to keep the current of each WLED string from changing appreciably during calibration and reducing current spikes;
a resistor having two ends, one end of the resistor being connected to ground; and
an amplifier comprising
a positive input terminal receiving the input reference voltage;
a negative input terminal being connected to the end of the resistor opposite to ground; and
an output terminal being connected respectively to the current regulators.

13. The self-calibrating WLED module as claimed in claim 12, wherein each current regulator comprises
a ground;
a V_{DD} source;
a logic module receiving the four control signals and the sequence signal from the controller and converting the four control signal to a corresponding control signals based on the sequence signal;
multiple switches being controlled by the voltage potential of the corresponding control signals that adjust servo loop configurations of the calibration current and comprising
a first switch being controlled by the first corresponding control signal which being closed when the first corresponding control signal being HIGH;
a second switch being controlled by the first corresponding control signal, which being closed when the first corresponding control signal being LOW;
a third switch being controlled by the second corresponding control signal, which being closed when the second corresponding control signal being HIGH;
a fourth switch being controlled by the second corresponding control signal, which being closed when the second corresponding control signal being LOW;
a fifth switch being controlled by the third corresponding control signal, which being closed when the third corresponding control signal being LOW;
a sixth switch being controlled by the fourth corresponding control signal, which being closed when the fourth corresponding control signal being HIGH; and
two seventh switches are closed when the fourth corresponding control signal being LOW;
a first transistor being activated to provides calibration current to the WLED string when the first switch being closed; and being deactivated when the when the first switch being opened and consequently the second switch being closed;
a second transistor provides current to the WLED strings when the current regulator is not calibrating the WLED strings and then stops producing required current to the WLED strings when the seventh switches are closed;
a first error amplifier;
a second error amplifier forcing current to flow through the second transistor and the WLED strings;
a third transistor;
a fourth transistor;
a fifth transistor forming a servo loop with the second transistor and the first error amplifier, which ensuring a drain voltage of the second transistor being equal to a drain voltage of the fifth transistor when the required current flowing through the drain of the second transistor;
a sixth transistor;
a seventh transistor;
a first capacitor having a sampled voltage that is the drain voltage of the second transistor and a drain voltage of first transistor when desired current flows through the first transistor and also through the WLED string;
a second capacitor having a voltage drop that causes the required current of the second transistor to be equal to the calibration current, and forces current through the seventh transistor that is indicative of the required current through the second transistor when the fifth switch is closed;
an eighth transistor having a mirrored current being compared to the current through the current reflected from the seventh transistor in order to produce a voltage at the drain of eighth transistor that is fed back to the gates of second transistor in order to complete the servo loop;
a second error amplifier forcing the drain voltage of the second transistor to be equal to the voltage stored on the first capacitor; and
the second error amplifier no longer forcing the drain voltage of the second transistor to cause the required current to flow to the WLED strings when the fifth switch being opened, the most recent voltage at the output of second error amplifier being stored on the second capacitor which causes the required current to flow through second transistor even though a servo loop through the second error amplifier is broken.

14. The self-calibrating WLED module as claimed in claim 13 further comprising a protecting transistor providing voltage protections to the drain of the first transistor and the second transistor and the negative input of the first error amplifier and comprising
a gate being connected to an external cascode bias circuit;
a drain being connected to the low voltage end of the WLED strings; and
a source being connected to the drain of the first transistor, the negative input terminal of the second error amplifier, the negative input terminal of the first error amplifier and the drain of the second transistor.

15. The self-calibrating WLED module as claimed in claim 14 further comprising a current stabilizer and startup detector that senses the calibration current through first transistor during start up, stores a representative value of that current as a voltage on a capacitor, then uses that voltage to maintain current in the WLED string at the same value until next calibration cycle.

16. The self-calibrating WLED module as claimed in claim 15, wherein the startup detector generates a fifth control signal when the current regulator is unable to provide its desired current and comprises
a second reference voltage
a comparator connected to the second reference voltage; and
a D Flip-Flop connected to the comparator and generating a reset signal that, based on the comparison of the gate voltage of the first transistor and the second reference voltage, which when sufficiently high, resets the D Flip-Flop making the fifth control signal go high and enabling the current stabilizer.

17. The self-calibrating WLED module as claimed in claim 16, wherein the current stabilizer comprises
a ground;
an eighth switch being controlled by the first corresponding control signal and being closed when the first corresponding control signal is HIGH;
a ninth switch being controlled by the fifth control signal and closed when the fifth control signal is HIGH;
a ninth transistor that feeds current to the eighth transistor when the ninth switch is closed;
a tenth transistor, a gate and drain of the tenth transistor being connected to a current source that is a fraction of the current in first transistor when it is providing the current through the WLED string; and
a third capacitor producing a current through the tenth transistor, when charged to a proper voltage, wherein the charged voltage induces a current in the ninth transistor forcing current in the second transistor to be equal to that of the first transistor.
